(19) United States
(12) Patent Application Publication
(10) Pub. No.: US 2013/0136716 A1
(43) Pub. Date: May 30, 2013

(54) ANTIFOULING COATING

(71) Applicants: Alexander Enström, Sandefjord (NO); Henning Johnsen, Sandefjord (NO); Cecilia Winander, Sandefjord (NO); Morten Eikenes, Sandefjord (NO)

(72) Inventors: Alexander Enström, Sandefjord (NO); Henning Johnsen, Sandefjord (NO); Cecilia Winander, Sandefjord (NO); Morten Eikenes, Sandefjord (NO)

(73) Assignee: JOTUN A/S, Sandefjord (NO)

(21) Appl. No.: 13/701,948

(22) PCT Filed: Jun. 3, 2011
(86) PCT No.: PCT/EP2011/059184

§ 371 Date: Feb. 12, 2013

(30) Foreign Application Priority Data
Jun. 4, 2010 (EP) 10164995.2

(51) Int. Cl. A01N 25/10; C09D 5/16; A01N 59/20

(52) U.S. Cl. CPC C09D 5/1662
USPC 424/78.09; 524/559; 106/266; 106/287.18

(57) ABSTRACT

A binder for an antifouling composition comprising a mixture of: (i) at least one organic monofunctional acid or a salt thereof; (ii) at least one organic polyfunctional acid having a molecular weight of 300 to less than 1000 or a salt thereof, e.g. a dimerised, trimerised or oligomerised fatty acid or resin acid; and (iii) at least one metal compound.

This invention relates to a binder composition for an antifouling coating as well as to an antifouling coating composition itself and a method for manufacturing and using that composition. In particular, the invention relates to a binder composition which comprises a polyfunctional acid, monofunctional organic acid and a metal salt.

Surfaces that are submerged in seawater are subjected to fouling by marine organisms such as green and brown algae, barnacles, mussels, tube worms and the like. On marine constructions such as vessels, oil platforms, buoys, etc. such fouling is undesired and has economical consequences. The fouling may lead to biological degradation of the surface, increased load and accelerated corrosion. On vessels the fouling will increase the frictional resistance which will cause reduced speed and/or increased fuel consumption. It can also result in reduced manoeuvrability.

To prevent settlement and growth of marine organisms antifouling paints are used. These paints generally comprise a film-forming binder, together with different components such as pigments, fillers, solvents and biologically active substances.

The most successful antifouling coating system on the market until 2003 was a tributyltin (TBT) self-polishing copolymer system. The binder system for these antifouling coatings was a linear acrylic copolymer with tributyltin pendant groups. In seawater the polymer was gradually hydrolysed releasing tributyltin, which is an effective biocide. The remaining acrylic copolymer, now containing carboxylic acid groups, became sufficiently soluble or dispersible in seawater to be washed out or eroded away from the coating surface. This self-polishing effect provided a controlled release of the biologically active compounds in the coating resulting in the excellent antifouling efficiency and smooth surfaces and hence reduced frictional resistance. TBT containing antifouling coatings are now prohibited on ship hulls.

In recent years new antifouling coating systems have been developed and introduced as a consequence of the TBT ban. One broad group of biocidal antifouling coatings on the market today is the self-polishing antifouling coatings which mimic the TBT self-polishing copolymer coatings. Those antifouling coatings are based on (meth)acrylic copolymers having pendant hydrolysable groups without biocidal properties. The hydrolysis mechanism is the same as in the TBT containing copolymers. This gives the same controlled dissolution of the polymers and thereby the controlled release of antifouling compounds from the coating film, resulting in similar performance as the TBT containing antifouling coating systems. The most successful self-polishing antifouling systems today are based on silyl ester functional (meth)acrylic copolymers. These coating compositions are for example described in, EP 0 646 630, EP 0 802 243, EP 1 342 756, EP 1 479 737, EP 1 641 862, WO 00/77102, WO 03/070832 and WO 03/080747.

The above mentioned antifouling coating systems degrade by hydrolysis of pendant groups on the polymer backbone, which results in a water erodable polymer. The hydrolysis of the pendant groups on the polymer backbone results in the formation of carboxylic acid salts which make the polymer hydrophilic and thereby erodable. A certain amount of hydrolysable groups are needed to get sufficient hydrophilicity and an erodable polymer after hydrolysis.

Another well known solution is the use of an acrylate polymer with metal ions in the side chains. These work through metal ion exchange resulting in an erodable polymer. One disadvantage with above mentioned technologies is that over time the high content of less soluble polymer backbone contributes to the formation of a leached layer.

Another way of obtaining water erodable polymers is by introducing hydrolysable groups in the polymer backbone itself, resulting in degradation of the polymer structure, which give erosion of the polymer film or coating film.

Polishing rate and leached layer (LL) build up are two important parameters determining the efficacy of a self polishing antifouling coating (SPC). Appropriate polishing rate will provide for continuous exposure of fresh paint and maintain adequate biocide concentration at the antifouling/seawater interface to prevent fouling at the hull. The formation of a leached layer however, will inhibit the efficacy of the antifouling paint. Higher biocide concentration within the paint formulation will be required to accommodate the presence of a leached layer for efficient fouling protection over time.

The present inventors have realised that by introducing a water erodable binder system for a self polishing antifouling coating, the polishing rate can be adjusted, the formation of a leached layer can be kept to a minimum and the biocide can be kept at an optimum level throughout the life-time of the coating. This method also allows the use of a lower content of biocide as the issue of leached layer formation is minimised. As the binder system contains water soluble bonds, the leached layer is kept to a minimum on the submerged surface on which the antifouling coating has been applied.

A binder system receiving its film forming properties from water soluble ionic bonds within an organic backbone, and where the insoluble organic segments are short enough to be easily eroded, will therefore be an effective film forming resin in antifouling paint systems. This will ensure that the leached layer will be kept at minimum throughout the life-time of the coating.

The present inventors have designed a binder system and hence an antifouling coating composition which is adjustable with regards to polishing rate and which keeps the leached layer to a minimum. The present invention relies on the combination of a monofunctional organic acid and an organic polyfunctional acid of low molecular weight, such as a dimerised acid, in combination with a metal compound. When applied to a vessel, the binder system of the invention forms a film in view of the network of ionic links formed between the carboxyl groups of the acids and the metal ion of the metal compound. As these links are all water soluble, the film is erodable and the leached layer is kept to a minimum.

The use of a water erodable binder in anti-fouling coatings is not new. GB 2,257,154 describes a soap formed by combining a metal salt with an unsaturated fatty acid and a second fatty acid. The metallic soap cures to a cross-linked film in air. The use therefore of film forming resins based on these simple soaps is known. In U.S. Pat. No. 5,545,823, the use of a similar soap is described this time in combination with an acrylate polymer. U.S. Pat. No. 5,382,281 discloses the use of further film forming metallic soaps based on unsaturated fatty acids.

U.S. Pat. No. 4,918,147 describes a metal containing resin composition formed with a base resin, metallic salt of an organic acid and a monobasic acid.

In Example 3 of GB 2257154, calcium hydroxide is used in conjunction with an acrylate oligomer and linseed oil fatty acid and used to form an antifouling paint. The acrylate oligomer however, has an Mw of more than 1400.

The present inventors have surprisingly found that an ideal film forming layer is provided by the specific combination of a low molecular weight polyfunctional acid, such as a dimerised, trimerised or oligomerised fatty or resin acid, in combination with a monofunctional organic acid and metal compound.

Thus viewed from one aspect the invention provides a binder for an antifouling composition comprising a mixture of:

(i) at least one organic monofunctional acid or a salt thereof;
(ii) at least one organic polyfunctional acid having a molecular weight of less than 1000, e.g. a dimerised, trimerised or oligomerised fatty acid or resin acid; and
(iii) at least one metal ion.

Viewed from another aspect the invention provides an antifouling coating comprising a binder as hereinbefore defined and at least one biologically active agent.

Viewed from another aspect the invention provides an antifouling coating comprising a mixture of:

(i) at least one organic monofunctional acid or a salt thereof;
(ii) at least one organic polyfunctional acid having a Mw of less than 1000 such as 300 to less than 1000;
(iii) at least one metal ion;

and at least one biologically active agent.

Viewed from a still further aspect, the invention provides a process for protecting a surface from fouling comprising coating that surface with an antifouling coating as hereinbefore defined.

Viewed from another aspect the invention provides the use of an antifouling coating as herein before defined in preventing fouling.

### DEFINITIONS

By polyfunctional acid is meant one which contains at least two COOH, —SO₃H group or —PO₃H groups. Preferably, the acids groups present are all of the same type, e.g. all COOH groups.

By dimerised acid is meant one formed by the joining together of two acid molecules which are preferably, but not necessarily, the same.

By trimerised acid is meant one formed by the joining together of three acid molecules which are preferably, but not necessarily, the same.

By oligomerised acid, e.g. oligomerised fatty or oligomerised resin acid is meant one comprising 4 to 8, preferably 4 or 5 acid groups per molecule and which is formed by the oligomerisation of an acid containing molecule.

By resin acid is typically meant one which is produced by parenchymatous epithelial cells that surround the resin ducts in trees from temperate coniferous forests. The resin acids are formed when two- and three-carbon molecules couple with isoprene building units to form mono- (volatile), sesqui- (volatile), and diterpene (nonvolatile) structures. Resin acids have two functional groups, carboxyl group and double bonds. Nearly all have the same basic skeleton: a 3-ring fused system with the empirical formula C₁₉H₂₉COOH or C₂₀H₃₀O₂.

The term fatty acid is used herein to refer to linear or branched, saturated or unsaturated, long chain (at least 8 carbon atoms) carboxylic acids containing C and H only (other than in the COOH group).

### DETAILED DESCRIPTION OF INVENTION

The binder system of the invention contains at least three components,

(i) at least one organic monofunctional acid or a salt thereof;

(ii) at least one organic polyfunctional acid having a molecular weight of less than 1000 or a salt thereof, e.g. a dimerised, trimerised or oligomerised fatty acid or resin acid; and

(iii) at least one metal ion.

Whilst the binder composition of the invention can be provided in any convenient form, such as an emulsion or dispersion, it is preferred if the binder composition of the invention is a solution, i.e. all the components are preferably dissolved in a solvent or mixture of solvents. Typically therefore the binder to which is added the anti-fouling components will contain a solvent. It will be appreciated that this solvent is removed in some way (e.g. it volatises) during coating application.

The first component of the binder is an organic monofunctional acid. It will have a single —COOH group, —SO₃H group or —PO₃H group. Preferably, the monofunctional acid is a monocarboxylic acid. Ideally, it is a C₄₋₃₀ monocarboxylic acid.

Suitable monoacids include resin acids such as rosins and other C₄-C₃₀ monofunctional acids such as the long chain fatty acids. Preferred rosins are wood rosin, tall oil rosin, gum rosin, hydrogenated and partially hydrogenated rosin, and disproportionated rosin.

Any acid may optionally carry a substituent such as an OH group or halo group. It is preferred that other than the acid group, the molecule contains only C and H atoms.

The monofunctional acid may be linear, branched or cyclic (E.g. polycyclic). It may be an aliphatic monofunctional acid or an aromatic monofunctional acid. It may be a saturated monofunctional acid or unsaturated monofunctional acid.

It will obviously be preferred if the monofunctional acid is readily available and cheap. Naturally occurring acids are especially preferred here. This makes fatty acids and resin acids an attractive option.

Aromatic or aliphatic acids which can be used in this regard include those of C4 to C30, preferably C6 to C25, such as C8 to C22 monofunctional acids, especially fatty acids (which may be saturated, monounsaturated or polyunsaturated) or resin acids. Highly preferred acids include tall oil derived acids or palmitic acid.

Specific linear acids of interest include capric acid, undecylic acid, lauric acid, tridecylic acid, myristic acid, pentadecylic acid, palmitic acid, margaric acid, stearic acid, nonadecylic acid, arachidic acid, heneicosylic acid and behenic acid.

Branched fatty acids, especially monobranched fatty acids are further preferred options such as isostearic acid By monobranched fatty acids is meant that there is a single branch in the fatty acid chain. Preferably the side chain formed is simply a methyl group.

Acids with highly branched alkyl groups that contain a tertiary carbon atom alpha to the COOH, e.g. having C5 to C19, preferably C13 to C19 atoms are also preferred, e.g. neodecanoic acid. These are sold, for example, under the trade name versatic acid. It will be appreciated that monofunctional acids of use in the invention may derive from natural sources then mixtures of various acids may be present.

The use of branched monofunctional acids or resin acids is especially preferred.

It is possible to use a mixture of monofunctional acids.

Most preferred acids include resin acids such as rosins and saturated fatty acids. An ideal component (i) includes the combination of a rosin compound with a monofunctional fatty acid compound. The rosin may form up to 10 vol % of the mixture.

The amount of monoacid employed in the binder may range from 1 to 99 wt %, such as 5 to 85 wt %, preferably, 5 to 80 wt % based on the combined weight of components (i) and (ii) of the binder. Preferably there will be a larger amount of monofunctional acid than polyfunctional acid.

The ratio between monoacid and polyfunctional acid is important. The hydrophilic properties can be altered by using different amounts of the monoacid and polyfunctional acid as well as the type of acid used. By changing the hydrophilic properties of the binder system the polishing rate can therefore be optimized.

The content of monofunctional acid in vol % in the binder may be 5-95 vol %, 30 to 90 vol %, such as 40 to 90 vol %. A larger amount of the monofunctional acid gives rise to a lower viscosity in the binder.

As discussed below, it will be appreciated that the monofunctional acid may also be provided as a metal salt.

Polyfunctional Acid, e.g. Dimerised, Trimerised or Oligomerised Acid

The second component of the invention is a polyfunctional acid having a molecular weight of less than 1000, such as 300 to less than 1000. By polyfunctional acid is meant that the compound contains two or more acid groups, especially carboxylic acid groups. Ideally, the Mw of the polyfunctional acid should be less than 800, especially less than 600. The skilled person can readily determine these low molecular weights. The use of gas chromatography-mass spectrometry (GCMS) is one well known method.

Preferably, the polyfunctional acid is a dimerised, trimerised or oligomerised acid. The polyfunctional acid is preferably not a polymer. The polyfunctional acid of the invention is preferably a dimerised, trimerised or oligomerised fatty acid or dimerised, trimerised or oligomerised resin acid, preferably dimerised or trimerised fatty or dimerised or trimerised resin acid, especially dimerised fatty or dimerised resin acid. The acid is preferably a fatty acid.

Thus the second component is preferably formed by dimerising, trimersing or oligomerising one acid or a mixture of acid derivatives to form a dimer, trimer or oligomer. The process can use any derivative of an acid (such as the acid itself or a salt thereof or an ester etc), as long as the acid form of the formed polyfunctional acid is eventually produced (perhaps after suitable hydrolysis etc).

It is preferred if a fatty acid dimer is employed. It will be appreciated that these materials are commercially available and that they will typically contain minor amounts of trimerised fatty acid, oligomeric components as well perhaps as residual unreacted monoacids.

Commercially available dimerised fatty acids mostly contain approximately 15 to 25 wt. % trimer and higher oligomers and 1 to 5 wt. % unreacted monomer with the remainder regarded as dimer. Where the major component is the dimer, this will be regarded as a dimer herein although preferably dimer should form at least 60 wt % of the product.

These products are commercially available under trade names such as Unidyme, Pripol, Radiacid and from suppliers such as Arizona Chemical Company, Croda chemicals and Oleon. The dimer of tall oil is especially preferred. In particular, dimerised fatty acids can be made using Diels Alder chemistry.

For the avoidance of doubt, an ester group is not considered an acid group herein. Ideally, therefore, the polyfunctional acid is formed by dimerising (or trimerising etc) at least one fatty acid (or derivative thereof that can subsequently be hydrolysed to a fatty acid).

The polyfunctional acid is preferably formed by the dimerisation or trimerisation of at least one fatty acid such as a C10-25 fatty acid, e.g. C16 to 22 fatty acid. The monomer may be linear or branched. Preferably, the fatty acid is unsaturated, especially polyunsaturated. The formed dimer acid may therefore contain from 32 to 44 carbon atoms in the molecule.

It will be appreciated that the source of the fatty acid is likely to be natural which means that there is likely to be a mixture of fatty acids present. There may also be other impurity components present.

Resin acids can also be dimerised. These are typically C18-21 acids, e.g. of general formula C19H₂₉COOH or C₂₀H₃₀O₂. Suitable resin acids are abietic acid, neoabietic acid, palustric acid, pimaric acid, isoprimaric acid, and levoprimaric acid. One example here is dimerised rosin.

The dimerisation normally takes place at temperatures between 180 and 270° C. under water vapour pressure and in the presence of approximately 2 to 10% clay catalyst.

The Mw (average molecular weight) of the polyfunctional acid is below 1000, such as 300 to 999.

The acid number of the polyfunctional acid may range from 100-500 mg KOH/g, preferably 150-210.

The amount of polyfunctional acid incorporated into the binder may be 1 to 99 wt %, such as 10 to 75 wt %, more preferably 10 to 50 wt % based on the weight of components (i) and (ii) of the binder.

The amount of polyfunctional acid employed in the binder may range from 10 to 70 vol %, such as 10 to 60 vol % based on the content of component i) and ii) of the binder. Preferably there is more monofunctional acid than polyfunctional acid.

By varying the amounts of acids present different properties can be achieved. Larger amounts of the monofunctional acid component allows the formation of a film layer that polishes more rapidly (i.e. its rate of erosion is faster). Increasing the polyfunctional acid content slows erosion rates. This gives the skilled man considerable freedom to tailor the binder composition to desired properties.

The weight ratio between mono and polyfunctional acids is preferably in the range 10:1 to 1:2, preferably 5:1 to 1:1, especially 4:1 to 2:1.

The volume ratio between mono and polyfunctional acids is preferably in the range 10:1 to 1:2, preferably 5:1 to 1:1, especially 4:1 to 2:1.

It has surprisingly been found that the acid combination in the binder of the invention allows the formation of coating compositions which leave a minimal amount of leached layer after prolonged exposure to seawater.

As discussed below, it will be appreciated that the polyfunctional acid may also be provided as a metal salt.

### Metal Ion

The binder of the invention contains a metal ion often provided by way of a metal compound. Suitable metal compounds are listed in EP-A-0204456.

It is of course possible however for the metal ion to be added as part of a salt of the monofunctional and/or polyfunctional acid. Thus, a binder containing a monofunctional acid salt and a polyfunctional acid salt is deemed herein to be one containing a monofunctional acid and a polyfunctional acid and a metal ion. Where therefore the metal ion is provided by way of a salt of one or both acid components there may be no need to add additional metal compound. It is preferred however if the monofunctional and polyfunctional components are provided as the free acid and hence a metal compound must also be added.

In particular, the metal compound is a metal salt. The metal salt is preferably a metal oxide, hydroxide, sulfide, chloride, nitrate, sulfate or carbonate. The most preferred option is an oxide. Mixtures of metal salts may also be employed.

The metal ion can be any metal ion from the periodic table although preferably this is an alkaline earth metal or transition metal ion, Al or Te. Ideally the metal ion is a first row transition metal or Mg or Ca. Preferably the metal ion is Cu, Mg, Ca, Zn, Co, Te or Mn, especially from Cu, Zn, or Mg, such as Cu or Zn. Preferred metal ions will be in at least the 2+ oxidation state, e.g. 2+ to 4+, especially 2+ oxidation state.

The highly preferred option is Zn, especially as part of zinc oxide.

The amount of metal compound employed can vary. Preferred amounts are 0.1 to 10 mole-equivalents metal compound, e.g. metal oxide, in relation to acid groups in the binder component, preferably 0.2 to 5 equivalents, especially 0.5 to 3 equivalents.

### Solvent

The binder of the invention preferably employs a solvent or mixture of solvents. The solvent used is any solvent which dissolves the acid components of the binder. Suitable solvents therefore include: water aromatic hydrocarbons such as xylene, white spirit, toluene; aliphatic hydrocarbons such as hexane and heptane; chlorinated hydrocarbons such as dichloromethane, trichloroethane, tetrachloroethane, fluorinated hydrocarbons such as difluoromethane, difluoroethane, trifluoroethane, tetrafluoroethane; fluorochloro-aliphatic and aromatic hydrocarbons such as chlorofluoromethane, chlorodifluoroethane, parachlorobenzotrifluoride; ketones such as acetone, methylethylketone, methylisobutylketone, cyclohexanone; esters such as methylacetate, ethylacetate, butylacetate, tert-butylacetate, ethyleneglycolmethyletheracetate; eters such as ethyleneglycoldimethylether, diethyleneglycoldimethylether, dibutylether, dioxane, tetrahydrofurane; alcohols such as methanol, ethanol, propanol, isopropanol, butanol, hexanol, benzylalcohol; ether alcohols such as butoxy ethanol, propylene glycolmonomethylether, amides such as N-methylpyrrolidone, dimethylformamide or solvents such as dimethylsulphoxide. Mixtures of the above mentioned solvents can also be used.

It is especially preferred if the solvent comprises an organic solvent. Especially preferred solvents are aromatic solvents, and alcohols. In particular a mixture of an aromatic solvent and an alcohol can be used. Highly preferred combinations are xylene and n-butanol.

The presence of water in the binding solution is also found to be advantageous, especially during formation of the binder. Without wishing to be limited by theory, it is envisaged that water helps solvate metal ions making them more available for reaction. The amount of water present may be up to 10 wt %, e.g. up to 5 wt %. The water can be removed, e.g. by azeotropic distillation before formation of the antifouling composition. It may be added alone with the organic solvent.

It is especially preferred if the presence of the solvent allows the formation of an essentially homogeneous binding solution, especially a solution. The amount of solvent used is preferably less than 60 wt % of the binder. The solids content of the binder is therefore preferably at least 40 wt %.

### Manufacture of Binder

In order to manufacture a binder system of the invention, the mixture of components is obtained and then preferably heated. The temperature may be up to 140° C. Obviously, any heating should be kept at a level below which any decomposition of the binder components occurs. Ideally, a solvent or solvents should be used. This yields a solution with film forming properties because of the formation of ionic bonds. The film forming properties of the resin of the invention rely on the water soluble metal-carboxylate bonds.

In one embodiment, all the acid employed is added to form a binder however, it is within the scope of the invention for additional acids to be added during paint formulation.

In one embodiment of the invention, the binder composition may be formed as a masterbatch. Thus, a “prebinder” composition can be made which comprises monofunctional acid, polyfunctional acid, metal salt and any solvent. The final properties of the anti-fouling composition (and hence also of the binder component) can then be further adjusted by the addition of more monofunctional acid component. This allows the skilled man to produce a variety of different binder compositions starting from the same masterbatch. Depending on the amount of additional monofunctional/polyfunctional acid added, a binder can be made which polishes fast or slow and which has a different viscosity. It is preferred if any water employed during binder manufacture is removed at this stage and before any anti-fouling components are added.

The amount of binder present will vary enormously depending on the design of the formulation. It some embodiments the binder may form up to 70 wt % or more of the anti-fouling composition. More usually, the binder may form 5 to 50 wt % of the overall anti-fouling composition, preferably 5 to 40 wt %, such as 10 to 35 wt %.

This binder component can then be mixed with conventional antifouling paint components to form a valuable anti-fouling coating. An antifouling coating of the invention may additionally contain standard additives. These include at least one biologically active agent such as Cu₂O. This should therefore act as a marine biocide.

By biologically active agent/compound is meant any chemical compound that prevents the settlement of marine organisms on a surface, and/or prevents the growth of marine organisms on a surface and/or encourages the dislodgement of marine organisms from a surface. Examples of inorganic biologically active compounds include copper and copper compounds such as copper oxides, e.g. cuprous oxide and cupric oxide; copper alloys, e.g. copper-nickel alloys; copper salts, e.g. copper thiocyanate, copper sulphide; and barium metaborate.

Examples of organometallic biologically active compounds include zinc pyrithione; organocopper compounds such as copper pyrithione, copper acetate, copper naphthenate, oxine copper, copper nonylphenolsulfonate, copper bis(ethylenediamine)bis(dodecylbenzensulfonate) and copper bis(pentachlorophenolate); dithiocarbamate compounds such as zinc bis(dimethyldithiocarbamate), zinc ethylenebis(dithiocarbamate), manganese ethylenebis(dithiocarbamate) and manganese ethylene bis(dithiocarbamate) complexed with zinc salt;

Examples of organic biologically active compounds include heterocyclic compounds such as 2-(tert-butylamino)-4-(cyclopropylamino)-6-(methylthio)-1,3,5-triazine, 4,5-dichloro-2-n-octyl-4-isothiazolin-3-one, 1,2-benzisothiazolin-3-one, 2-(thiocyanatomethylthio)-1,3-benzothiazole and 2,3,5,6-tetrachloro-4-(methylsulphonyl)pyridine; urea derivatives such as 3-(3,4-dichlorophenyl)-1,1-dimethylurea; amides and imides of carboxylic acids, sulphonic acids and sulphenic acids such as N-(dichlorofluoromethylthio)phthalimide, N-dichlorofluoromethylthio-N′,N′-dimethyl-N-phenylsulfamide, N-dichlorofluoromethylthio-N′,N′-dimethyl-N-p-tolylsulfamide and N-(2,4,6-trichlorophenyl)maleimide; other organic compounds such as pyridine triphenylborane, amine triphenylborane, 3-iodo-2-propynyl N-butylcarbamate, 2,4,5,6-tetrachloroisophthalonitrile and p-((diiodomethyl)sulphonyl)toluene.

Other examples of biologically active agents may be tetraalkylphosphonium halogenides, guanidine derivatives, imidazole containing compounds such as medetomidine and derivatives and enzymes such as oxidase, proteolytically, hemicellulolytically, cellulolytically, lipolytically and amylolytically active enzymes.

Optionally the biologically active compounds may be encapsulated or adsorbed on an inert carrier or bonded to other materials for controlled release.

The biologically active compounds may be used alone or in mixtures. The use of these biologically active agents is known in anti-fouling coatings and their use would be familiar to the skilled man.

The total amount of biologically active agent in the antifouling compositions of the invention may be in the range 0.5 to 80 wt %, such as 1 to 70 wt % in the paint composition or more preferably, in the dry film. It will be appreciated that the amount of this component will vary depending on the end use and the biologically active compound used.

The antifouling coating composition according to the present invention optionally comprise one or more components selected among other binders, pigments, extenders and fillers, dehydrating agents and drying agents, additives, solvents and thinners.

An additional binder can be used to adjust the self-polishing properties and the mechanical properties of the antifouling coating film. Examples of binders that can be used in addition to the binder composition in the antifouling coating composition according to the present invention include:

maleic acid esters, fumaric acid esters and other esters of rosin and hydrogenated rosin, copper resinate, zinc resinate, calcium resinate, magnesium resinate and other metal resinates of rosin and polymerised rosin and others as described in WO 97/44401;

silyl ester copolymers, for example as described in U.S. Pat. No. 4,593,055, EP 0 646 630 and NO 2007 3499;

acid functional polymers of which the acid group is blocked with divalent metals bonded to a monovalent organic residue, for example as described in EP 0 204 456 and EP 0 342 276; or divalent metals bonded to a hydroxyl residue, for example as described in GB 2 311 070 and EP 0 982 324; or amine for example as described in EP 0 529 693;

hydrophilic copolymers for example (meth)acrylate copolymers as described in GB 2 152 947 and poly(N-vinyl pyrrolidone) copolymers and other copolymers as described in EP 0 526 441;

(meth)acrylic polymers and copolymers, based on monomers such as n-butyl acrylate, methyl methacrylate and methyl ethacrylate, e.g. poly(n-butyl acrylate-co-isobutyl vinyl ether), in particular having Mw from 5000-50000 and a carboxylic acid monomer moiety;

vinyl ether polymers and copolymers, such as poly(methyl vinyl ether), poly(ethyl vinyl ether), poly(isobutyl vinyl ether), poly(vinyl chloride-co-isobutyl vinyl ether);

aliphatic polyesters, such as poly(lactic acid), poly(glycolic acid), poly(2-hydroxybutyric acid), poly(3-hydroxybutyric acid), poly(4-hydroxyvaleric acid), polycaprolactone and aliphatic polyester copolymer containing two or more of the units selected from the above mentioned units;

metal containing polyesters for example as described in EP 1 033 392 and EP 1 072 625;

alkyd resins and modified alkyd resins;

petroleum resins and coumarone-indene resins; and

other condensation polymers as described in WO 96/14362.

These additional binder components may form up to 50 wt % of the binder, e.g. 1 to 15 vol %. It is preferred if no conventional polymers such as acrylates or polyesters are integrated.

Petroleum resins and coumarone-indene resins of interest generally have molecular weights ranging from 250 to 10,000 and softening points up to 180° C. The petroleum resins can be both aromatic (C9) and aliphatic (C5). The raw materials used for making hydrocarbon resins are polymerisable components of the C9 fraction, i.e. alkylaromatic mono-olefins with 8-10 carbon atoms, such as vinyltoluenes, alpha-methylstyrene, styrene, methylindenes and indene and polymerisable components of the C5 fraction, i.e. aliphatic and cycloaliphatic diolefins, such as isoprene, piperylene and cyclopentadiene. These resins can be modified, e.g. by phenol and maleic anhydride to introduce hydroxyl and carboxyl functionality and/or undergo chemical treatment, e.g. hydrogenation.

Examples of pigments are inorganic pigments such as titanium dioxide, iron oxides, zinc oxide, zinc phosphate, graphite and carbon black; organic pigments such as phthalocyanine compounds and azo pigments.

Examples of extenders and fillers are minerals such as dolomite, plastorite, calcite, quartz, barite, magnesite, aragonite, silica, wollastonite, talc, chlorite, mica, kaolin and feldspar; synthetic inorganic compounds such as calcium carbonate, magnesium carbonate, barium sulphate, calcium silicate and silica; polymeric and inorganic microspheres such as uncoated or coated hollow and solid glass beads, uncoated or coated hollow and solid ceramic beads, porous and compact beads of polymeric materials such as poly(methyl methacrylate), poly(methyl methacrylate-co-ethylene glycol dimethacrylate), poly(styrene-co-ethylene glycol dimethacrylate), poly(styrene-co-divinylbenzene), polystyrene, poly(vinyl chloride).

Examples of additives that can be added to an antifouling coating composition are reinforcing agents, thixotropic agents, thickening agents, anti-settling agents, plasticizers and solvents.

Examples of reinforcing agents are flakes and fibres. Fibres include natural and synthetic inorganic fibres such as silicon-containing fibres, carbon fibres, oxide fibres, carbide fibres, nitride fibres, sulphide fibres, phosphate fibres, mineral fibres; metallic fibres; natural and synthetic organic fibres such as cellulose fibres, rubber fibres, acrylic fibres, polyamide fibres, polyimide, polyester fibres, polyhydrazide fibres, polyvinylchloride fibres, polyethylene fibres and others as described in WO 00/77102. Preferably, the fibres have an average length of 25 to 2,000 μm and an average thickness of 1 to 50 μm with a ratio between the average length and the average thickness of at least 5.

Examples of thixotropic agents, thickening agents and anti-settling agents are silicas such as fumed silicas, organo-modified clays, amide waxes, polyamide waxes, amide derivatives, polyethylene waxes, oxidised polyethylene waxes, hydrogenated castor oil wax, ethyl cellulose, aluminium stearates and mixtures thereof.

Examples of plasticizers are chlorinated paraffins, phthalates, phosphate esters, sulphonamides, adipates and epoxidised vegetable oils. The addition of plasticizers improves cracking resistance.

Preferred plasticizers are sulphonamides such as H-ethyl-para-toluene-sulphonamide and alkyl-paratoluene-sulphonamide;

adipates such as bis(2-ethylhexyl)adipate, diisobutyladipate and dioctyladipate; and others such as phosphoric acid triethylester, butylstearat, sorbitantrioleate and epoxydized soya(bean)oil;

phtalates such as dibutylphtalate and benzylbutylphtalate, dioctylphtalate, dinonylphtalate and diisodecylphtalate; and

phosphate esters such as tricresylphosphate, nonylphenylphosphate, octyloxypoly(ethyleneoxy)ethylphosphate, tributoxyethylphosphate, isooctylphosphate and 2-ethylhexyl-diphenylphosphate.

It is particularly preferred if a hydrocarbon resin is used as a plastisizer to improve the mechanical properties of the composition and especially to resist cracking Suitable amounts of these components are less than 20 wt % of the paint composition e.g. 1 to 20 wt %, 2-15 vol % of the dry binder components (in the dry film). These plasticizers give little or no cracking in the formed film whilst polishing properties are not affected.

Furthermore, it may be important to incorporate antioxidants into the composition. The antioxidants can prevent oxidation of the double bonds present in the monofunctional or polyfunctional acids. This may influence the mechanical properties, especially maintaining the initial mechanical properties (more flexible, less cracking etc).

In general, any of the above optional components can be present in an amount ranging from 0.1 to 50 wt %, typically 0.5 to 20 wt %, preferably 0.75 to 15 wt % of the antifouling composition. It will be appreciated that the amount of these optional components will vary depending on the end use.

It is highly preferred if the antifouling composition contains a solvent in addition to that of the binder component. This solvent is preferably volatile and is preferably organic. Examples of organic solvents and thinners are aromatic hydrocarbons such as xylene, toluene, mesitylene; ketones methyl ethyl ketone, methyl isobutyl ketone, methyl isoamyl ketone, cyclopentanone, cyclohexanone; esters such as butyl acetate, tert-butyl acetate, amyl acetate, isoamyl acetate, ethylene glycol methyl ether acetate; ethers such as ethylene glycol dimethyl ether, diethylene glycol dimethyl ether, dibutyl ether, dioxane, tetrahydrofuran, alcohols such as n-butanol, isobutanol, benzyl alcohol; ether alcohols such as butoxyethanol, 1-methoxy-2-propanol; aliphatic hydrocarbons such as white spirit; and optionally a mixture of two or more solvents and thinners.

Preferred solvents are aromatic solvents, especially xylene and mixtures of aromatic hydrocarbons.

The solvent content may be up to 50 wt % of the composition, preferably up to 45 wt % of the composition, such as up to 40 wt % but may be as low as 15 wt % or less, e.g. 10 wt % or less. Again, the skilled man will appreciate that the solvent content will vary depending on the other components present and the end use of the coating composition. In particular, the presence or absence of CuO is important for determining the overall solvent and binder content

The antifouling coating composition of the invention should preferably have solids content above 60 wt %, e.g. above 70% by weight, such as above 75 wt %, preferably above 80 wt %. By solids content is meant the content on non volatile components in the composition. It is measured by ISO 3251.

More preferably the antifouling coating composition should have a content of volatile organic compounds (VOC) below 400 g/L, e.g. below 390 g/L., more preferably less than 375 g/L, especially less than 350 g/L. VOC content can be calculated (ASTM D5201-01) or measured (ASTM D3960-02), preferably measured.

The antifouling coating composition of the invention can be applied to a whole or part of any object surface which is subject to fouling. The surface may be permanently or intermittently underwater (e.g. through tide movement, different cargo loading or swell). The object surface will typically be the hull of a vessel or surface of a fixed marine object such as an oil platform or buoy. Application of the coating composition can be accomplished by any convenient means, e.g. via painting (e.g. with brush or roller) or spraying the coating onto the object. Typically the surface will need to be separated from the seawater to allow coating. The application of the coating can be achieved as conventionally known in the art.

The invention will now be described further with reference to the following non limiting figures and examples.

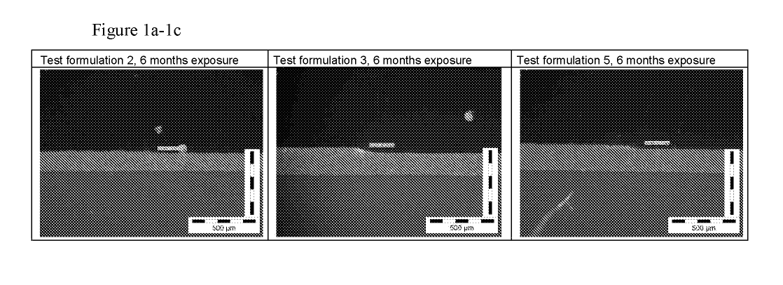

FIG. 1a-c show results for formulations 3-5 of the invention after 6 months exposure.

### EXAMPLES

The following abbreviations are used:
Rosin Gum rosin
Rosin60X 60 wt % solution of gum rosin in Xylene

### TOFA Tall Oil Fatty Acid

DFA 1 Dimerized fatty acid, Unidyme 30 from Arizona chemicals
DFA 2 Hydrogenated dimer acid, Radiacid 0960 from Oleon
DFA 3 Hydrogenated double distilled dimer acid, Radiacid 0975 from Oleon
DFA 4 Hydrogenated double distilled dimer acid, Radiacid 0976 from Oleon
Dimerized rosin Dymerex from Eastman
ISA Isostearic acid
Hydrogenated rosin Foral AX-E from Eastman
VA10 Versatic acid 10 from Momentive
All dimerised fatty acids have a molecular weight of between 300 and less than 1000 g/mol.

### Analytical Procedures

### Determination of Solids Content of the Polymer Solutions

The solids content in the polymer solutions are determined in accordance with ISO 3251. A test sample of 0.6 g±0.1 g are taken out and dried in a ventilated oven at 150° C. for 30 minutes. The weight of the residual material is considered to be the non-volatile matter (NVM). The non-volatile matter content is expressed in weight percent. The value given is the average of three parallels.

The volatile organic compound (VOC) content of the antifouling coating composition is calculated in accordance with ASTM D5201.

### Example 1

### Binder Solutions

### General Procedure for Preparation of Binder Solution

A quantity of solvent(s), di or tri or oligofunctional acid and a monofunctional acid are charged into a temperature-controlled reaction vessel equipped with a stirrer, a condenser, a Dean and Stark trap, a nitrogen inlet. The reaction vessel is heated and maintained at the reaction temperature of 80-90° C. A metal compound (or mixture of metal compounds) and water is added to the reaction vessel under a nitrogen atmosphere. The reaction vessel is maintained at the reaction temperature for a further 2-5 hours.

A monofunctional (or a mixture of more than one monofuctional) acid can then be added to the reaction vessel (additional monofunctional acid).

The temperature is then increased slowly to 110° C. and water is removed by azeotropic distillation and then cooled to room temperature.

The composition of the binder solutions are given in Table 1.

TABLE 1
Binder compositions: Ingredients in parts by weight.

| | | B1 | B2 | B3 | B4 | B5 |
|---|---|---|---|---|---|---|
| Polyfunctional | DFA 1 | 30.9 | 23.6 | 29.1 | 31.2 | 28.6 |
| organic acid | DFA 2 | 0 | 0 | 0 | 0 | 0 |
| | DFA 3 | 0 | 0 | 0 | 0 | 0 |
| | DFA 4 | 0 | 0 | 0 | 0 | 0 |
| | Dimerized rosin | 0 | 0 | 0 | 0 | 0 |
| Organic | Rosin | 0 | 13.1 | 0 | 0 | 7.9 |
| monoacid | TOFA | 0 | 0 | 7.4 | 5.3 | 0 |
| | ISA | 5.6 | 0 | 0 | 0 | 0 |
| | VA10 | 0 | 0 | 0 | 0 | 0 |
| | Hydrogenated rosin | 0 | 0 | 0 | 0 | 0 |
| Metal | ZnO | 5.4 | 5.3 | 5.4 | 5.4 | 5.3 |
| compound | MgO | 0 | 0 | 0 | 0 | 0 |
| | Cu(OH)₂ | 0 | 0 | 0 | 0 | 0 |
| | n-butanol | 20.5 | 20.5 | 20.5 | 20.5 | 20.5 |
| Solvent | Xylene | 30.7 | 32.6 | 30.7 | 30.7 | 32.6 |
| | Water | 2.3 | 2.3 | 2.3 | 2.3 | 2.3 |
| | Rosin | 0 | 2.8 | 0 | 0 | 4.7 |
| Additional | TOFA | 0 | 0 | 4.7 | 4.7 | 0 |
| monoacid | ISA | 4.7 | 0 | 0 | 0 | 0 |
| | NVM (wt %) | 46.9 | 46.9 | 47.8 | 47.0 | 47.3 |
| Binder | Viscosity (kg/(s*m)) | 540 | 338 | 490 | 13700 | 12150 |
| properties | Specific graviy | 0.93 | 0.93 | 0.93 | 0.93 | 0.93 |
| | (g/cm³) | | | | | |

TABLE 2
Components in parts by weight

| | | Ba | Bb | Bc | Bd | Be |
|---|---|---|---|---|---|---|
| Polyfunctional | DFA 1 | 32.6 | 23.6 | 29.1 | 31.2 | 28.6 |
| organic acid | | | | | | |
| Organic | Rosin | 0 | 0 | 0 | 0 | 17.9 |
| monoacid | | | | | | |
| Organic | TOFA | 0 | 15.8 | 12.0 | 9.9 | 0 |
| monoacid | | | | | | |
| Organic | ISA | 10.0 | 0 | 0 | 0.00 | 0 |
| monoacid | | | | | | |
| Metal | ZnO | 5.2 | 5.2 | 5.4 | 5.4 | 5.3 |
| Compound | | | | | | |
| Solvent 1 | n-Butanol (%) | 19.9 | 20.5 | 20.5 | 20.5 | 20.5 |
| Solvent 2 | Xylene | 29.9 | 32.6 | 30.7 | 30.7 | 25.4 |
| Solvent 3 | Water | 2.3 | 2.3 | 2.3 | 2.3 | 2.3 |
| Binder | NVM (wt %) | 46.9 | 46.9 | 47.8 | 47 | 47.3 |
| properties | Specific | 0.9 | 0.9 | 0.9 | 0.9 | 0.9 |
| | Gravity | | | | | |
| | (g/cm³) | | | | | |

TABLE 3
Ingredients in parts by weight

| | | B6 | B7 | B8 | B9 | B10 | B11 | B12 | B13 | B14 | B15 | B16 |
|---|---|---|---|---|---|---|---|---|---|---|---|---|
| Polyfunctional | DFA 1 | 31.0 | 0 | 0 | 0 | 28.6 | 33.5 | 0 | 13.5 | 30.2 | 33.0 | 30.1 |
| organic acid | DFA 2 | 0 | 31.5 | 0 | 0 | 0 | 0 | 0 | 0 | 0 | 0 | 0 |
| | DFA 3 | 0 | 0 | 31.4 | 0 | 0 | 0 | 0 | 0 | 0 | 0 | 0 |
| | DFA 4 | 0 | 0 | 0 | 31.4 | 0 | 0 | 0 | 0 | 0 | 0 | 0 |
| | Dimerized | 0 | 0 | 0 | 0 | 0 | 0 | 34.1 | 19.1 | 0 | 0 | 0 |
| | rosin | | | | | | | | | | | |
| Organic | Rosin | 0 | 0 | 0 | 0 | 0 | 0 | 0 | 7.5 | 0 | 4.6 | 4.2 |
| monoacid | TOFA | 0 | 0 | 0 | 0 | 0 | 0 | 0 | 0 | 0 | 0 | 0 |
| | ISA | 8.4 | 8.1 | 8.1 | 8.1 | 7.0 | 0 | 6.5 | 0 | 0 | 4.5 | 4.1 |
| | VA10 | 0 | 0 | 0 | 0 | 0 | 5.4 | 0 | 0 | 0 | 0 | 0 |
| | Hydrogenated | 0 | 0 | 0 | 0 | 0 | 0 | 0 | 0 | 9.4 | 0 | 0 |
| | rosin | | | | | | | | | | | |
| Metal | ZnO | 5.8 | 5.5 | 5.6 | 5.6 | 5.2 | 6.2 | 4.5 | 5.0 | 5.6 | 0 | 0 |
| compound | MgO | 0 | 0 | 0 | 0 | 0 | 0 | 0 | 0 | 0 | 3.0 | 0 |
| Solvent | Cu(OH)₂ | 0 | 0 | 0 | 0 | 0 | 0 | 0 | 0 | 0 | 0 | 6.7 |
| | n-butanol | 21.4 | 21.5 | 21.5 | 21.5 | 19.4 | 21.4 | 21.6 | 21.5 | 21.5 | 21.4 | 21.5 |
| | Xylene | 32.2 | 32.2 | 32.2 | 32.2 | 29.1 | 32.1 | 32.3 | 32.3 | 32.2 | 32.1 | 32.2 |
| | Water | 1.3 | 1.2 | 1.2 | 1.2 | 1.3 | 1.4 | 1.0 | 1.1 | 1.2 | 1.4 | 1.2 |
| | Rosin | 0 | 0 | 0 | 0 | 0 | 0 | 0 | 0 | 0 | 0 | 0 |
| Additional | TOFA | 0 | 0 | 0 | 0 | 0 | 0 | 0 | 0 | 0 | 0 | 0 |
| monoacid | ISA | 0 | 0 | 0 | 0 | 9.4 | 0 | 0 | 0 | 0 | 0 | 0 |
| | NVM (wt %) | 46.2 | 45.9 | 45.5 | 45.9 | 50.0 | 47.0 | 45.6 | 46.2 | 46.5 | 49.8 | 45.9 |
| Binder | Viscosity | 47990 | 10400 | 7500 | 8500 | 600 | 10348 | 40 | 402 | 8050 | 23500 | 23445 |
| properties | (kg/(s*m)) | | | | | | | | | | | |
| | Specific | 0.93 | 0.92 | 0.93 | 0.92 | 0.92 | 0.93 | 0.96 | 0.95 | 0.94 | 0.92 | 0.94 |
| | gravity | | | | | | | | | | | |
| | (g/cm³) | | | | | | | | | | | |

### Coating Compositions

### General Procedure for Preparation of Antifouling Coating Composition

The ingredients are mixed and ground to a fineness of <30 μm using a high-speed disperser. Any ingredients sensitive to the high shear forces and temperature in the grinding process is added in the let-down. The general compositions of the coating compositions are presented in Table 4 and 5.

TABLE 4

| | | Test formulations 1 to 5 (parts in wt %) | | | | |
|---|---|---|---|---|---|---|
| | | 1 | 2 | 3 | 4 | 5 |
| Binder | B1 | 8.3 | 0 | 0 | 0 | 0 |
| Binder | B2 | 0 | 32.8 | 0 | 0 | 0 |
| Binder | B3 | 0 | 0 | 20.9 | 0 | 0 |
| Binder | B4 | 0 | 0 | 0 | 8.4 | 0 |
| Binder | B5 | 0 | 0 | 0 | 0 | 20.9 |
| Organic | Rosin60X | 19.7 | 0 | 0 | 0 | 0 |
| monoacid | | | | | | |
| Organic | TOFA | 0 | 0 | 5.0 | 10.1 | 0 |
| monoacid | | | | | | |
| Organic | ISA | 0 | 0 | 0 | 0 | 5.0 |
| monoacid | | | | | | |
| Additive | Byk-P104-S | 0.5 | 0.8 | 0.5 | 0.5 | 0.5 |
| Additive | Agualon 8X | 2.9 | 2.9 | 2.9 | 2.9 | 2.9 |
| Biocide 1 | Zineb | 5.3 | 5.2 | 5.3 | 5.4 | 5.3 |
| | Nautec | | | | | |
| Biocide 2 | Cuprous | 32.7 | 32.3 | 32.9 | 33.3 | 33.0 |
| | oxide | | | | | |
| Biocide 3 | Copper | 1.8 | 1.8 | 1.8 | 1.8 | 1.8 |
| | omadine | | | | | |
| Filler | Microdol 1 | 2.0 | 2.0 | 2.0 | 2.0 | 2.0 |
| Pigment 1 | Titanium | 3.4 | 3.4 | 3.5 | 3.5 | 3.5 |
| | dioxide | | | | | |
| Pigment 2 | Zinc Oxide | 18.4 | 18.2 | 18.6 | 18.8 | 18.6 |
| Solvent 1 | Xylene | 4.3 | 0 | 5.9 | 12.5 | 5.8 |
| Solvent 2 | Solvesso 100 | 0.6 | 0.6 | 0.6 | 0.6 | 0.6 |

TABLE 5

| | | Test formulation (wt %) | | | | | | | | |
|---|---|---|---|---|---|---|---|---|---|---|
| | | 6 | 7 | 8 | 9 | 10 | 11 | 12 | 13 | 14 |
| Binder | B6 | 16.2 | 8.1 | 0 | 0 | 0 | 0 | 16.0 | 0 | 0 |
| | B7 | 0 | 0 | 0 | 8.1 | 0 | 0 | 0 | 0 | 0 |
| | B8 | 0 | 0 | 0 | 0 | 8.1 | 0 | 0 | 16.1 | 0 |
| | B9 | 0 | 0 | 0 | 0 | 0 | 8.1 | 0 | 0 | 0 |
| | B10 | 0 | 0 | 19.7 | 0 | 0 | 0 | 0 | 0 | 0 |
| | B11 | 0 | 0 | 0 | 0 | 0 | 0 | 0 | 0 | 17.4 |
| Organic | Rosin60X | 0 | 0 | 0 | 0 | 0 | 0 | 13.3 | 7.4 | 0 |
| monoacid | ISA | 7.4 | 10.4 | 5.6 | 10.4 | 10.4 | 10.4 | 0 | 3.7 | 7.4 |
| Plasticizer | Novares LC65 | 0 | 0.9 | 0 | 0.9 | 0.9 | 0.9 | 0.9 | 0 | 0 |
| Additives | Byk-P 104-S | 0.5 | 0.5 | 0.5 | 0.5 | 0.5 | 0.5 | 0.5 | 0.5 | 0.5 |
| | Disparlon A603-20X | 1.5 | 1.5 | 1.5 | 1.5 | 1.5 | 1.5 | 1.5 | 1.5 | 1.5 |
| | Zineb Nautec | 1.9 | 1.9 | 1.9 | 1.9 | 1.9 | 1.9 | 1.9 | 1.9 | 1.9 |
| Biocides | Cuprous oxide | 36.4 | 36.3 | 36.1 | 36.3 | 36.3 | 36.3 | 35.8 | 36.1 | 36.9 |
| | Copper omadine | 1.4 | 1.4 | 1.4 | 1.4 | 1.4 | 1.4 | 1.4 | 1.4 | 1.5 |
| Filler | Minex S-10 | 2.1 | 2.1 | 2.1 | 2.1 | 2.1 | 2.1 | 2.1 | 2.1 | 5.3 |
| | Titanium dioxide | 1.9 | 1.9 | 1.9 | 1.9 | 1.9 | 1.9 | 1.9 | 1.9 | 4.7 |
| Pigments | Iron oxide | 1.7 | 1.7 | 1.7 | 1.7 | 1.7 | 1.7 | 1.7 | 1.7 | 4.3 |
| | Zinc oxide | 20.6 | 20.6 | 20.5 | 20.6 | 20.6 | 20.6 | 20.3 | 20.4 | 7.2 |
| Solvents | Xylene | 9.8 | 14.1 | 8.7 | 14.1 | 14.1 | 14.1 | 4.4 | 6.8 | 13.0 |

### Determination of Polishing Rates of Antifouling Coating Films in Sea Water

The polishing rate is determined by measuring the reduction in film thickness of a coating film over time. For this test PVC discs are used. The coating compositions are applied as radial stripes on the disc using a film applicator. The thickness of the dry coating films are measured by means of a suitable electronic film thickness gauge. The PVC discs are mounted on a shaft and rotated in a container in which seawater is flowing through. Natural seawater which has been filtered and temperature-adjusted to 25° C.±2° C. is used. The PVC discs are taken out at regular intervals for measuring the film thickness. The discs are rinsed and allowed to dry overnight at room temperature before measuring the film thickness.

### Determination of Leached Layer Formation of Antifouling Coating Films in Sea Water

The antifouling film is exposed according to procedure to determine polishing rate in seawater described in the above section. A cross section of the paint stripe is analyzed in microscope to determine formation of leached layer (LL). During this analysis the polishing (Pol) can also be determined by comparison with a non-polishing reference. The test results of test formulations 1 to 5 and standard product references are listed in table 6 and 7 below:

TABLE 6

| | | 3 months | | 6 months | |
|---|---|---|---|---|---|
| | | exposure | | exposure | |
| | | Pol | LL | Pol | LL |
| | | (μm) | (μm) | (μm) | (μm) |
| Patent | Test formulation 1 | 20 | 20 | 40 | 20 |
| formulation | | | | | |
| Patent | Test formulation 2 | 10 | 0 | 15 | 0 |
| formulation | | | | | |
| Patent | Test formulation 3 | 10 | 25 | 40 | 0 |
| formulation | | | | | |
| Patent | Test formulation 4 | 55 | 15 | 85 | 20 |
| formulation | | | | | |
| Patent | Test formulation 5 | 10 | 10 | 25 | 0 |
| formulation | | | | | |
| Reference 1 | Interspeed 340 | 35 | 35 | 35 | 40 |
| Reference 2 | Interswift 655 | 20 | 40 | 35 | 40 |

TABLE 7

3 months exposure

| | Polishing (μm) | Leached layer (μm) |
|---|---|---|
| Test formulation 6 | 5-10 | 15-20 |
| Test formulation 7 | 15 | 15 |
| Test formulation 8 | 5-10 | 10-15 |
| Test formulation 9 | 15-20 | 15-20 |
| Test formulation 10 | 15-20 | 15-20 |
| Test formulation 11 | 10-15 | 10-15 |
| Test formulation 12 | 5-10 | 20-25 |
| Test formulation 13 | 5-10 | 15-20 |
| Test formulation 14 | 10 | 30 |

Interspeed and Interswift are commercial products from International Paint. Interswift 655 is based on copper acrylate technology. Interspeed is a rosin based coating.

1. A binder for an antifouling composition comprising a mixture of:
at least one organic monofunctional acid or a salt thereof;
at least one organic polyfunctional acid having a molecular weight of 300 to less than 1000 or a salt thereof; and
at least one metal compound.

2. The binder of claim 1, wherein the monofunctional acid is a carboxylic acid or a salt thereof.

3. The binder of claim 2, wherein the monofunctional acid is a fatty acid or resin acid or a salt thereof.

4. The binder of claim 3, wherein the monofunctional acid is a branched fatty acid or a salt thereof.

5. The binder of claim 1, wherein the polyfunctional acid is a dimerised, trimerised or oligomerised carboxylic acid or a salt thereof.

6. The binder of claim 1, wherein the polyfunctional acid is a dimerised fatty acid or resin acid or a salt thereof.

7. The binder of claim 1, wherein the monofunctional acid forms 5 to 80 wt % of the binder based on the content of the monofunctional acid and polyfunctional acid components only.

8. The binder as claimed of claim 1, wherein the volume ratio between mono and polyfunctional acids is in the range of 10:1 to 1:2.

9. The binder of claim 1, wherein the metal ion is Cu, Zn or Mg.

10. The binder of claim 1, wherein the binder is in the form of a solution in an organic solvent.

11. The binder of claim 10 wherein the solution further comprises water.

12. An antifouling coating comprising:
a binder;
at least one biologically active agent;
wherein the binder comprises:
at least one organic monofunctional acid or a salt thereof;
at least one organic polyfunctional acid having a molecular weight of 300 to less than 1000 or a salt thereof; and
at least one metal compound.

13. A process for protecting a surface from fouling comprising coating said surface with an antifouling coating, the antifouling coating comprising the binder of claim 1 and at least one biologically active agent.

14. (canceled)

15. The antifouling coating of claim 12, wherein the polyfunctional acid is a dimerised, trimerised or oligomerised fatty acid or resin acid or a salt thereof.

16. The antifouling coating of claim 15, wherein the polyfunctional acid is a dimerised fatty acid or resin acid or a salt thereof.

17. The antifouling coating of claim 12, wherein the monofunctional acid is a fatty acid or resin acid or a salt thereof.

18. The antifouling coating of claim 12, wherein the antifouling coating further comprises an organic solvent.

19. The antifouling coating of claim 12, wherein the at least one biologically active agent is an inorganic copper compound.

20. The process of claim 13, wherein the monofunctional acid is a fatty acid or resin acid or a salt thereof.

21. The process of claim 13, wherein the polyfunctional acid is a dimerised fatty acid or resin acid or a salt thereof.
